(19) United States
(12) Patent Application Publication
(10) Pub. No.: US 2017/0316368 A1
(43) Pub. Date: Nov. 2, 2017

(54) Sign or Advertising Management Application for a Smart Phone

(71) Applicants: Christopher P. Morrison, Del Mar, CA (US); Wissam Fakih, Carlsbad, CA (US)

(72) Inventors: Christopher P. Morrison, Del Mar, CA (US); Wissam Fakih, Carlsbad, CA (US)

(21) Appl. No.: 15/498,642

(22) Filed: Apr. 27, 2017

Related U.S. Application Data
(60) Provisional application No. 62/391,332, filed on Apr. 27, 2016.

(51) Int. Cl. G06Q 10/06; G09F 19/00; G06Q 99/00; G06F 17/30

(52) U.S. Cl. CPC G06Q 10/063118; G09F 19/00; G06Q 99/00; G06Q 10/06313; G06F 17/30241

(57) ABSTRACT

The invention is a telephonic app which permits the user to place and remove advertising signs using specialized geographic algorithms, which place optimal positions for the sign to be placed at. The sign is to be placed for a specific time period, once the time period is reached, it is to be removed. Geo-tracking devices are placed on the signs permitting the location for placement and removal to be performed by a contractor. Although the invention was initially designed for the Realty industry, any signage which is time sensitive could benefit from this invention.

### PRIORITY

This application claims priority from U.S. Provisional Patent Application Ser. 62/391,322, entitled Sign or Advertising Management Application for a Smart Phone, filed on Apr. 27, 2016.

### BACKGROUND OF THE INVENTION

### Field of the Invention

The present invention relates generally to Smartphone applications, widgets or the like and, more specifically, to an app that will allow the user to manage the placement and removal of signs, which may be employed by Realtors who are having an open house by putting them in touch with a vendor who will put up and take down the signs at the desired location and in a timely manner. This smartphone app is not limited to Realty signage, but for other signage that is to be placed at a location for a certain period of time. Examples of such signs include signs announcing an event, signs encouraging the population to vote, advertising signs, marketing signs, yard sale signs, or signs promoting a new store or the like.

The driver smart phone screen will display a map of the area in which the signs are to be placed and later collected and removed. A plurality of auto populated pins will indicate where the signs are to be placed on the map. Software is employed, using an automated auto-populated sign distribution algorithm, which determines an efficient route of both the placement of signs, as well as the removal of signs, the placement of signs would be indicated by a pin on the map. The pin on the map is not a literal pin on a map, but a digital map with a digital indicator where the sign is to be placed. The system includes a central control which shows the same maps and pins; on a desktop or laptop computer or even a central smartphone, along with a driver smartphone in which the driver would drive and place a geo-tagged sign at the location which is indicated on each of the pins. The signs for any of a plurality of reasons, must be taken down to comply with local laws as well as collecting the signs for the next opening or event.

### Description of the Prior Art

There are other various mobile and computer applications which provide for bringing together a user requiring a service with a person to perform the labor involved. However just the contact information itself is not enough in many situations where, for example, multiple locations for the positioning of signs may be needed to be communicated. It is thus desirable to provide an application where the location of the signs needed are located and marked on a map available to both the contractor and the client in real time through a computer and a smartphone. It is further desirable to have an application where both the placing and removal of the signs is scheduled by the client and coordinated with the contractor. It is an advantage that this system may be employed in a plurality of methods. Several obvious methods of use have been described herein.

### SUMMARY OF THE PRESENT INVENTION

An application for smartphones, tablets, computer, and the like is disclosed. The application allows a user to contact a pool of drivers/contractors who will place a set number of signs at predetermined locations with another set time for taking them down. The application allows the user to auto-populate the signs around a specific address and then move them to any other desired location on the map if needed. Various packages involving the number of signs and the timing of their placement and removal could be preset in the application.

A primary object of the present invention is to provide an application that allows the user to contact a pool of driver/contractors established to place and remove signs or the like in predetermined locations.

Another object of the present invention is to provide an application where the user creates a profile which the potential contractors may review.

Yet another object of the present invention is to provide an application where the address and time of the needed sign placement or removal is communicated to the pool of contractors who may then indicate their willingness to perform the task.

Still yet another object of the present invention is to provide an application where various packages with corresponding prices (number of signs to be placed and removed) are available to the user.

Another object of the present invention is to provide an application where placement of the required signs is auto-populated by the software, the number being determined by the package (contract) chosen and where the user can the customize the location and placement of the various signs.

Yet another object of the present invention is to provide an application where the auto-populated signs are indicated by pins on a map of the area surrounding the address of the contract.

Still yet another object of the present invention is to provide an application where the price of the service, the placement and the removal of the signs at a specific time, is agreed on or negotiated beforehand.

Additional objects of the present invention will appear as the description proceeds.

The present invention overcomes the shortcomings of the prior art by providing a sign placement and removal service where the user and the contractor coordinate the timing and placement of various signs in a neighborhood or area, agree on a price for the service and the date and time of both the placement and take-down of the signs.

The foregoing and other objects and advantages will appear from the description to follow. In the description reference is made to the accompanying drawings, which forms a part hereof. Various embodiments will be described in sufficient detail to enable those skilled in the art to practice the invention, and it is to be understood that other embodiments may be implied by the description herein.

The following detailed description is, therefore, not to be taken in any limiting sense.

### BRIEF DESCRIPTION OF THE DRAWINGS

In order that the invention may be more fully understood, it will now be described, by way of example, with reference to the accompanying drawing in which:

FIG. 1 is a flow chart diagram of the operation of the present invention.

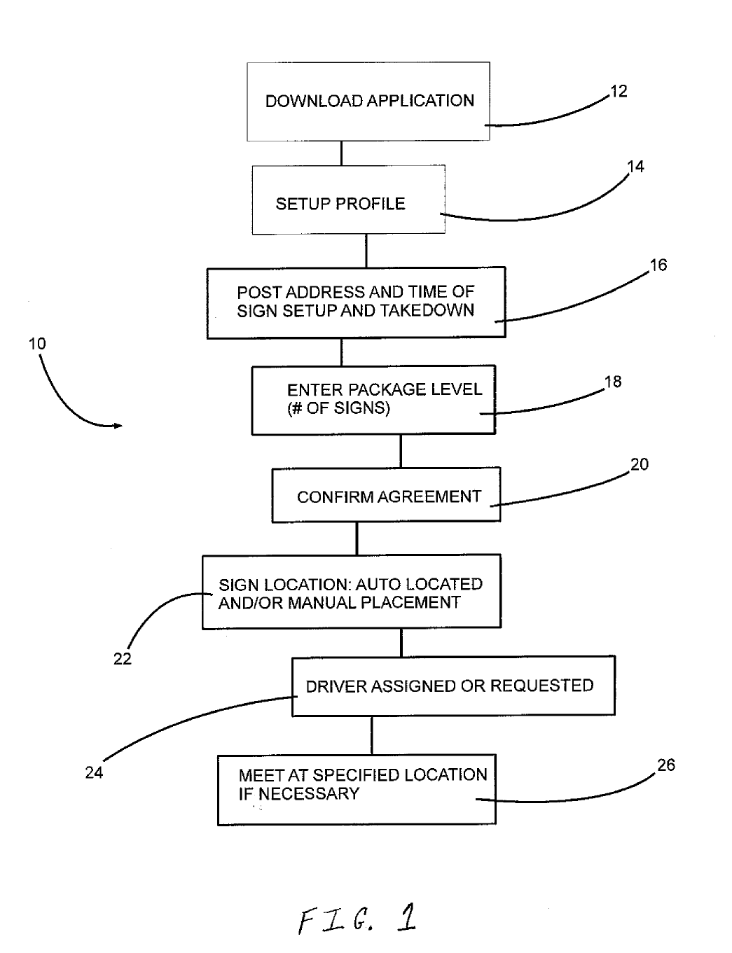

FIG. 2 shows a generic smartphone implementing the invention showing pins 1-20 at different spatial distances laid out on a map.

### DETAILED DESCRIPTION OF THE PREFERRED EMBODIMENT

The following discussion describes in detail one embodiment of the invention. This discussion should not be taken as limiting the invention to any particular embodiments as practitioners skilled in the art will recognize numerous other embodiments as well.

The timely setting up and taking down of signs can be very important in a number of jobs. Real Estate Open Houses, for example, require both that the signs be placed appropriately, and then removed after the property has been shown to interested parties. The putting up and taking down of signs is a time-consuming and labor intensive task that many people (such as real estate agents) do not want to do since it can involve getting wet, dirty, and tired which is not the best position to be in if you are frying to make a good impression and hopefully a sale. Many real estate agents are middle-aged and additionally, many of them are women. Messing up their clothes and appearance immediately prior to greeting potential clients is something that most of them would wish to avoid. The present invention deals with this issue by providing an application that matches up with a pool of vetted drivers who will put up the agreed upon number of signs in the predetermined locations and then take them down at another agreed upon time.

Referring to the Figure, the steps of the present invention are generally indicated at 10. The user downloads the application into their smartphone, computer or both, from an online source (or loads it from portable media) as indicated at 12. The profile setup is indicated at 14. This setup would include information that a potential driver or contractor would wish to know before accepting the contract. Phone numbers, email addresses, physical addresses and the like would be available here.

After the user has set up the profile they may post an address and time for when the signs need to be placed as indicated at 16. This would preferably include a map or a link to a map that would allow the potential contractor to decide whether or not they were interested.

The package level is entered and displayed as seen at 18. The package level would include the number of signs that would be required at the location(s) and, as above, would reflect the time that the setup and take-down would need to take place. The user would then confirm that the information such as the price of the contract represented is correct as indicated at 20.

The discussion now turns to the step involving the placement of the signs which is seen at 22. the application could have an auto-populate default mode where the signs location would be determined by traffic flows, corner line-of-sight, or other algorithm that the user may choose. Additionally it is contemplated that the user could manually place or move the signs which might be represented on a map screen by colored pins or the like by selecting them and dragging them to a location better suited to the purpose of the sign. Once the sign location has been determined, the user may then leave the assignment open or request a driver based on past experience. This step is indicated at 24.

If necessary, the user and the contractor could arrange a meeting prior to the placement and/or removal of the signs to assure that the job is accomplished to both sides satisfaction as seen at 26. Further referring to element 16 on the flowchart, the signs would be picked up by the contractor within a specified period of time and said signs would be return to the Realtor in this instance.

Though real estate signs are discussed above, the present invention 10 could be used in a variety of situations. Businesses in general or having specific time-sensitive sales could take advantage of the present invention. Events with directional signs could be accommodated. Garage sales could additionally be advertised by this method. Another use for the present invention would be political signs during a campaign season where their timely removal would obviate neighborhood complaints and prevent the inadvertent violation of local laws or neighborhood covenants.

It is contemplated that the pool of drivers that the application would draw on would be thoroughly vetted with background checks and the like.

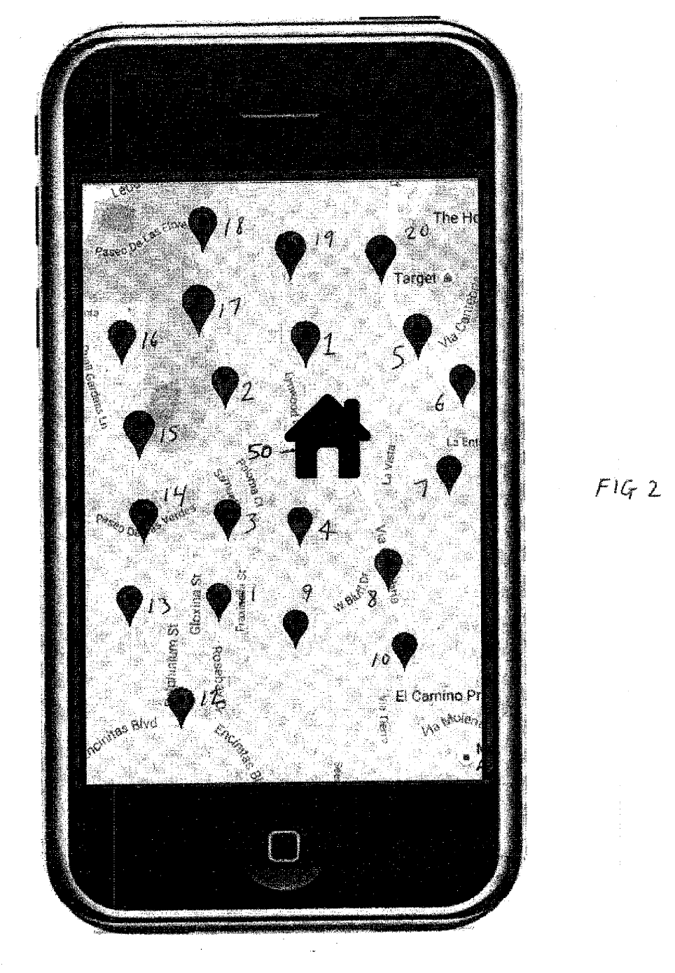

FIG. 2 shows a generic smartphone implementing the invention showing pins 1-20 at different spatial distances laid out on a map. The invention employs an automated auto-populated sign distribution algorithm. The house 50 for sale or rent has a plurality of signs placed about it in a smart fashion. Roads which may get more traffic may be assigned more signs. Also the user of the invention can choose the number of signs to be placed strategically around the house. In FIG. 2, 20 (twenty) signs have been selected as an example of the number of signs to be employed. A microprocessor has information input into it such as the location of the house. At this point the auto-population subroutine generates 20 (twenty) locations to place the signs. The signs are geo-tagged for use with the software. A geo-tagged sticker or other location device will be placed on the twenty signs. The signs are then placed at the locations generated on the smartphone. The application software will also suggest a route for the efficient placement and removal of the signs. In this embodiment the signs are placed at the locations on the smartphone according to a route for the most efficient placement of signs and subsequent removal of the same.

A second phone or other computer will show the same map, pin locations generated thereon and the house for sale or rent. As the signs are placed in their designated points, the color of the pin in question will change, denoting that sign #1 has been placed at location #1 generated by the software and visually implemented on the smartphone and computer. As the signs are placed at there designated points, soon all of the pins will have changed color, allowing both parties to know that the first half of the job is complete. The smartphone will suggest the order in which the signs are placed. FIG. 2, has 20 pins as can be clearly seen. These pin number represent where the signs are to be placed as well as the order they should be placed in for the most efficient placement. The signs are to be kept at their locations for a time period. A Realtor may show a house only on a weekend or another special period. Thus, these signs must be taken down after the weekend showing or other special event occurs. In some jurisdictions, signs for elections must be taken down within a short period of time after the election, or that candidate will be fined. Although such tough penalties may not be used in the Realty business, one would not want to advertise a house which has already be sold or rented. One would not want the company name to be an eyesore either. Therefore, once the time period has ended, the signs are to be picked up in the reverse manner in which they were laid down, with the pins showing once again in real time their removal by the pin changing color. When all of the signs are collected they are returned to the Realtor and the contractor is paid.

Auto population of the signs location is a key factor. The auto-populated pins will show up on the map where the signs go. In one embodiment, the pins can be numbered for sign set up with Pin #1 being the first pin closest to the house 50 and work outward with Pin #20 being the last pin furthest from the house 50. When it is time to pick up of the signs, the driver will pick up the farthest pin first and end up picking up Pin #1 last, then returning the signs to the house 50. The application will also direct the driver in a “route” for both placing signs and removing signs for maximum efficiency. This will be integrated into the software so that it tells the driver the sign locations and the order to setup and take down. The signs are auto-populated and delivered and placed in sequence, and the signs are taken down in the reverse sequence once the designated elapsed time has passed.

The pins will change color in real time, able to be seen by both the user and the driver. This allows the user to see that the job is done correctly.

The signs will be geo-tagged to transmit positional and other data such as, but not limited to time. The geo-tag device may be adhesively attached to the sign. The geo-tag may give data in latitude and longitude which then can be placed on the map so that the exact location is known.

Another important aspect of this invention is the amount of time that the sign is in position, advertising the open house, garage sale, a voting sign or the like. The signs employed in this invention are to be placed in their location for a limited period of time. For instance, a house showing may only be for a weekend, a garage sale perhaps only a′day. That is why the retrieval of the signs at the agreed upon time is so critical.

Although the invention can be used for Realty Signs, it is not limited solely to such signs. Other signs, such as those for garage sales, yard sales, school activities, and many other signs are considered to be part of this invention. Any signage which is designed to be placed for a specific limited period of time can benefit from this invention.

Without further analysis, the foregoing will so fully reveal the gist of the present invention that others can, by applying current knowledge, readily adapt it for various other uses without omitting features that, from the standpoint of prior art, fairly constitute essential characteristics of the generic or specific aspects of this invention.

In summary, the invention is directed to an application for smartphones, tablets, computer, and the like is disclosed. The application allows a user to contact a pool of drivers/contractors who will place a set number of signs at predetermined locations with another set time for taking them down. The application allows the user to auto-populate the signs around a specific address and the move them to any other desired location on the map if needed. Various packages involving the number of signs and the timing of their placement and removal could be preset in the application.

1. We claim a computer program which is implemented as a telephonic application to perform the steps of:
inputting an address of a house which is desired to be sold,
inputting the date and time of sign setup and removal,
inputting the number of advertising signs desired to be employed,
having an algorithm auto-populate a number of designated points equal to the number of advertising signs to be employed in which to place advertising signs for said home,
providing a smartphone to a contractor, said smartphone having a map displaying said plurality of designated points on said map to place said advertising signs for said home,
said contractor placing an advertising sign at a first designated point to a last designated point, inclusive of all designated points in between.

2. We claim a computer program which is implemented as a telephonic application as claimed in claim 1 to further perform the step of changing the color of a pin icon representing said designated point when said advertising sign is properly placed.

3. We claim a computer program which is implemented as a telephonic application as claimed in claim 3 to further perform the steps of retrieving said advertising signs after a pre-set period of time which has been entered into said computer program has elapsed, employing the telephonic application to pick up said advertising signs from said last designated point to said first designated point, and further bringing said advertising signs back to the Realtor.

4. We claim a computer program which is implemented as a telephonic application as claimed in claim 3 to further perform the step of changing the color of a pin icon representing said designated point when said advertising sign is removed.

5. We claim a computer program which is implemented as a telephonic application as claimed in claim 4 wherein said telephonic application generates data which may be stored in memory, including said data such as the address, date, time and open house traffic, said data will be compiled and analyzed for use in the housing industry, additionally, said compiled and said analyzed said data will be manufactured into reports for agents, homeowners and neighborhoods.

6. We claim a computer program which is implemented as a telephonic application as claimed in claim 1 to place a geo-tag on each of said advertising signs for said home, thus relaying the position of said advertising signs.
